(19) United States
(12) Patent Application Publication
(10) Pub. No.: US 2005/0137021 A1
(43) Pub. Date: Jun. 23, 2005

(54) Method of reducing torque shock on a transmission

(76) Inventor: Anton Juranko, Edmonton (CA)

Correspondence Address: R.F. Gallagher, 7420 Milner Dr., Colorado Springs, CO, 80920, US

(21) Appl. No.: 10/743,078

(22) Filed: Dec. 23, 2003

(51) Int. Cl. F16D 3/28

(52) U.S. Cl. 464/71

(57) ABSTRACT

Torque shock peaks when an automatic transmission shifts gears. A method of reducing this torque shock to prolong the life of engines, transmissions, and the entire power train in vehicles and heavy equipment most generally comprises the steps of transmitting rotational power through a torque shock absorber having a generally cylindrical housing adapted for attachment to a drive on one cylindrical end and to a driven shaft on the other cylindrical end. Thereby peak torque loads transmitted through the torque shock absorber are reduced. In a preferred embodiment of the invention the torque shock absorber comprises a housing having peripheral spaced bolts therethrough. Bolt openings therein are surrounded by a rubber bushing in the housing so that when the torque shock absorber is bolted to a driven flange peak torque loads are absorbed by the rubber bushings. The most preferred placement for the torque shock absorber in the power train is between an engine and an automatic transmission.

### FIELD OF THE INVENTION

This invention relates to torque shock experienced between an engine and an automatic transmission when gears are shifted. More particularly this invention relates to a method of reducing this torque shock to prolong the life of engines, transmissions, and the entire power train in vehicles and heavy equipment.

### BACKGROUND OF THE INVENTION

Torque shock between power sources and remotely mounted automatic transmissions has long been, and continues to be a problem. Torque shock is not only hard on automatic transmissions, but on the crank shaft of engines, and the entire drive train in vehicles. Particularly on larger trucks, and on heavy equipment having automatic transmissions, fast, forceful, and sudden contact between shifting gears roughly jerks the entire vehicle. High rpm shifts, either up or down, generate substantial torque shock. This torque shock results in a premature failure of engines, transmissions, drive shafts, and differentials. To correct the problem of torque shock, a torque shock absorbing apparatus that decreases the peak torque shock when gears are automatically shifted, is needed.

The inventor has determined that the best position for the torque shock absorber is directly on the engine or power source, before the automatic transmission. When installed, the torque shock absorber absorbs torque buildup during gear shifting. Drive shaft vibrations are eliminated. The torque shock absorber not only promotes smoother shifting of gears, and a smoother acceleration of the vehicle, but most importantly it reduces fatigue and wear on gears, bearings, and shafts within the transmission, as well as within all components within the entire remainder of the drive train. Peak torque and wear, and all of the resulting fatigue and failure of gears, shafts, bearings, universal joints, all along the entire drive train can be substantially reduced. While a torque shock absorber can compliment small vehicles having small engines and power transmission, the torque shock absorber has most immediate application on relatively large vehicles having large engines which transmit substantial power.

### OBJECTS OF THE INVENTION

It is an object of this invention to disclose a method of substantially reducing maintenance, and extending the life of engines, automatic transmissions, and all other components in the drive train of a vehicle. It is an object of this invention to disclose a method of reducing peak torque caused by both up and down shifting of gears. It is yet a further object of this invention to disclose a method of producing smoother acceleration and deceleration of a vehicle.

One aspect of this invention provides for a method of reducing this torque shock to prolong the life of engines, transmissions, and the entire power train in vehicles and heavy equipment most generally comprises the steps of transmitting rotational power through a torque shock absorber having a generally cylindrical housing adapted for attachment to a drive on one cylindrical end and to a driven shaft on the other cylindrical end. Thereby peak torque loads transmitted through the torque shock absorber are reduced.

In a preferred aspect of this invention a preferred embodiment provides for the torque shock absorber comprising a housing having peripheral spaced bolts therethrough. Bolt openings therein are surrounded by a rubber bushing in the housing so that when the torque shock absorber is bolted to a driven flange peak torque loads are absorbed by the rubber bushings. The most preferred placement for the torque shock absorber in the power train is between an engine and an automatic transmission.

Various other objects, advantages and features of this invention will become apparent to those skilled in the art from the following description in conjunction with the accompanying drawings.

### FIGURES OF THE INVENTION

FIG. 1 is a cross sectional view of a torque shock absorber mounted on a flywheel transmitting power to a driven shaft.

FIG. 2 is a front view of the torque shock absorber shown in FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

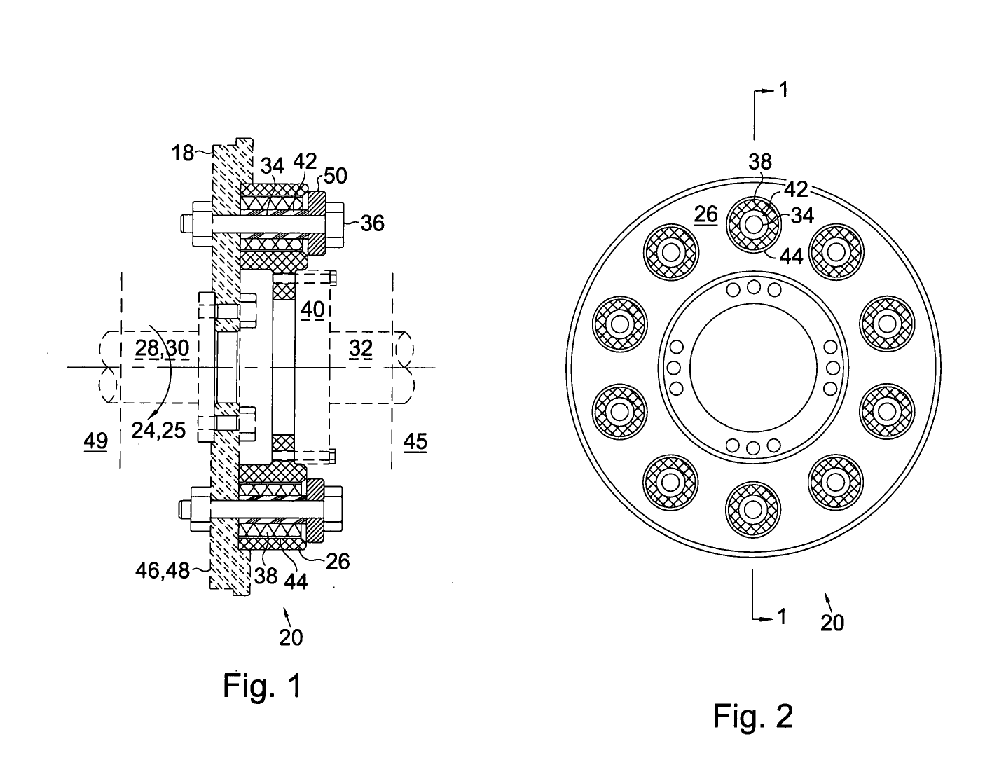

Turning now to the drawings and more particularly to FIG. 1 we have a perspective view of a cross sectional view of a torque shock absorber 20 mounted on a flywheel 18 transmitting power to a driven shaft 32. Most generally a method of reducing peak torque loads 25 caused by automatic gear shifting comprises the steps of: transmitting rotational power 24 through a torque shock absorber 20, having a generally cylindrical housing 26 adapted for attachment to a drive shaft 28 on one cylindrical end, and to a driven shaft 32 on the other cylindrical end. Thereby peak torque loads 25 transmitted through the torque shock absorber 20 are reduced.

The torque shock absorber 20 comprises a housing 26 having peripheral spaced bolt openings 34 and having bolts 36 therethrough. Said bolt openings 34 are surrounded by a rubber bushing 38 in the housing 26 so that when the torque shock absorber 20 is bolted to a driven flange 40 peak torque loads 25 are absorbed by the rubber bushings 38. Within this specification rubber is defined to include a resilient plastic.

In the most preferred embodiment of the invention the rubber bushings 38 are surround a steel bolt sleeve 42. The rubber bushings 38 are surrounded by a cylindrical steel ring 44 to facilitate positioning them within the housing 26. The rubber bushings are bonded between the steel bolt sleeve 42 and the cylindrical steel ring 44. A centering flange 50 maintains the rubber bushings 38 within the bushing 26. In the most preferred embodiment of the invention the drive shaft 28 and drive flange 46 comprises a fly wheel 48 turned by a crankshaft 30 on an internal combustion engine 49. The driven shaft 32 is adapted to be driven by a driven flange 40 bolted to an inner central portion of the driven end of the generally cylindrical torque shock absorber 20. The driven shaft 32 inputs power to an automatic transmission 45.

While the invention has been described with preferred specific embodiments thereof, it will be understood that this description is intended to illustrate and not to limit the scope of the invention, which is defined by the following claims.

1) A method of reducing peak torque loads caused by automatic gear shifting comprising the steps of:
transmitting rotational power through a torque shock absorber having a generally cylindrical housing adapted for attachment to a drive on one cylindrical end and to a driven shaft on the other cylindrical end;
so that peak torque loads transmitted through the torque shock absorber are reduced.

2) A method of reducing peak torque loads as in claim 1 wherein the torque shock absorber comprises a housing having peripheral spaced bolts through openings therein and wherein said bolt openings are surrounded by a rubber bushing in the housing so that when the torque shock absorber is bolted to a driven flange peak torque loads are absorbed by the rubber bushings.

3) A method as in claim 2 wherein the rubber bushings surround a steel bolt sleeve.

4) A method as in claim 2 wherein the rubber bushings are surrounded by a cylindrical steel ring to facilitate positioning with in the housing.

5) A method as in claim 2 wherein the drive shaft and drive flange comprises fly wheel turned by a crankshaft on an internal combustion engine.

6) A method as in claim 5 further wherein the driven shaft is adapted to be driven by a driven flange bolted to an inner central portion of the driven end of the generally cylindrical torque shock absorber.

7) A method as in 6 wherein the driven shaft inputs power to an automatic transmission.
